(19) United States
(12) Patent Application Publication
(10) Pub. No.: US 2015/0003951 A1
(43) Pub. Date: Jan. 1, 2015

(54) HIGH PERFORMANCE TAPE SYSTEM

(71) Applicant: International Business Machines Corporation, Armonk, NY (US)

(72) Inventors: John S. Best, San Jose, CA (US); A. David Erpelding, San Jose, CA (US); Steven R. Hetzler, Los Altos, CA (US); Daniel F. Smith, Felton, CA (US)

(21) Appl. No.: 13/931,634

(22) Filed: Jun. 28, 2013

(51) Int. Cl. B25J 11/00; G11B 33/06

(52) U.S. Cl. CPC B25J 11/00; G11B 33/06
USPC 414/749.1; 414/589

(57) ABSTRACT

A system includes a tape support surface configured to receive a plurality of tape spools, and a plurality of robotic accessors capable of picking the tape spools from the tape support surface, transporting the tape spools, and releasing the tape spools at a drop location. The accessors are capable of passing each other during the transporting. Another system includes a first tape support surface configured to receive a plurality of tape spools, a second tape support surface facing the first tape support surface, and a plurality of robotic accessors capable of picking the tape spools from the tape support surface, transporting the tape spools, and releasing the tape spools at a drop location. At least one of the accessors is capable of picking tape spools from both tape support surfaces.

### BACKGROUND

The present invention relates to data storage systems, and more particularly, this invention relates to tape systems having fast tape pickup and delivery mechanisms.

In magnetic storage systems, data is read from and written onto magnetic recording media utilizing magnetic transducers. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning the magnetic read transducer and then sensing the magnetic field of the magnetic media. Read and write operations may be independently synchronized with the movement of the media to ensure that the data can be read from and written to the desired location on the media.

In the near future, with the adoption of improved media, the cost of storing information (on a per byte basis) on tape is expected to decline rapidly with respect to magnetic disk. Also, short-term and long-term reliability will continue to favor tape-based storage. Furthermore, as more mass storage is allocated to cloud networks, most storage will be in large libraries, rather than on individual drives, which is a consideration favoring tape-based storage. One historical disadvantage of tape-based storage with respect to disk-based storage was the relatively poor access time associated with tape-based storage, with the time required to bring the tape to the tape drive and then spool the tape to the file location typically averaging about 40 seconds or more.

### BRIEF SUMMARY

A system according to one embodiment includes a tape support surface configured to receive a plurality of tape spools, and a plurality of robotic accessors capable of picking the tape spools from the tape support surface, transporting the tape spools, and releasing the tape spools at a drop location. The accessors are capable of passing each other during the transporting.

A system according to another embodiment includes a first tape support surface configured to receive a plurality of tape spools, a second tape support surface facing the first tape support surface, and a plurality of robotic accessors capable of picking the tape spools from the tape support surface, transporting the tape spools, and releasing the tape spools at a drop location. At least one of the accessors is capable of picking tape spools from both tape support surfaces.

Any of these embodiments may be implemented in a magnetic data storage system such as a tape drive system, which may include a magnetic head, a drive mechanism for passing a magnetic medium (e.g., recording tape) over the magnetic head, and a controller electrically coupled to the magnetic head.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a partial exploded view of a system for storing and transporting media, according to one embodiment.

FIG. 2 is a partial exploded view of a system for storing and transporting media, according to one embodiment.

FIG. 3 is a partial exploded view of a system for storing and transporting media, according to one embodiment.

FIG. 4 is a partial exploded view of a system for storing and transporting media, according to one embodiment.

FIG. 5 is a partial exploded view of a system for storing and transporting media, according to one embodiment.

FIG. 6A is a schematic diagram of a simplified tape drive system according to one embodiment.

FIG. 6B is a schematic diagram of a tape cartridge according to one embodiment.

FIGS. 7A-7C are schematic representations of tape threading, according to one embodiment.

FIGS. 8A-8D are schematic representations of steps for tape self-threading using a tape drive, according to one embodiment.

FIGS. 9A-9C are schematic representations of steps using flange extenders, according to one embodiment.

FIG. 10A is an illustration of an optical pattern on a surface, according to one embodiment.

FIG. 10B is a partial side view of a surface configuration, according to one embodiment.

FIG. 10C is a partial side view of a surface configuration, according to one embodiment.

FIG. 10D is a partial side view of a surface configuration, according to one embodiment.

FIG. 10E is a partial side view of a surface configuration, according to one embodiment.

FIG. 11 is a depiction of a network architecture, in accordance with one embodiment.

FIG. 12 is a system diagram of a representative hardware environment that may be associated with the servers and/or clients of FIG. 11, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of magnetic storage systems, as well as operation and/or component parts thereof. Particularly, various embodiments provide mechanisms for accessing tape at high speeds using pick and place robotics, such as in a gantry arrangement. In one embodiment, a system provides multiple gantry type robotic accessors capable of fully servicing a set of tape spools, while also providing improved throughput and reliability. A further aspect is the ability to improve the volumetric density by disposing tape spools on two surfaces serviceable by one or all of the robots. Some approaches provide the advantage of the ability to have multiple robots service the same set of tape spools for improved throughput and reliability.

In one general embodiment, a system includes a tape support surface configured to receive a plurality of tape spools, and a plurality of robotic accessors capable of picking the tape spools from the tape support surface, transporting the tape spools, and releasing the tape spools at a drop location. The accessors are capable of passing each other during the transporting.

In another general embodiment, a system includes a first tape support surface configured to receive a plurality of tape spools, a second tape support surface facing the first tape support surface, and a plurality of robotic accessors capable of picking the tape spools from the tape support surface, transporting the tape spools, and releasing the tape spools at a drop location. At least one of the accessors is capable of picking tape spools from both tape support surfaces.

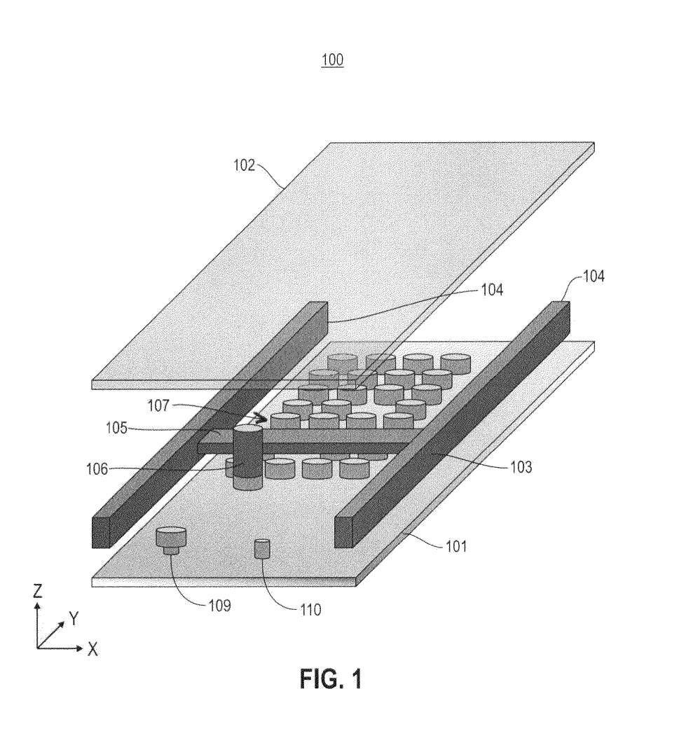

A basic system configuration is shown in FIG. 1 in exploded view, according to one embodiment. The tape system 100 includes tape support surface 101, with tape spool set 107 disposed on the surface. The spools are deliverable to drops 109, 110, such as at a tape drive, winder, elevator, etc. as discussed in more detail below. A robotic accessor 103 is configured as a gantry in this embodiment. A pair of fixed side rails 104 run along either side of the tape support surface 101. Cross bar 105 travels along the side rails in the Y direction. The cross bar 105 may be driven by any known mechanism, such as chain drive, cable drive, actuator, motorized wheel, worm screw, etc.

Picker 106 slides along the cross bar in the X direction, and can pick up and carry tape spools. The picker 106 may be driven along the cross bar by any known mechanism, such as chain drive, cable drive, actuator, motorized wheel, worm screw, etc. The picker 106 may be designed to use any of various approaches to pick the tape spools, such as using a clip, a claw, magnetic attraction, suction, etc.

An enclosure 102 may be present to enclose the system 100. Also, while not shown, the enclosure may include walls.

This approach, while adequate for some uses, is not optimal because it does not provide for scalable performance other than by increasing the speed of the robotic accessor itself. A further disadvantage is that if the robotic accessor fails, the system is unable to access the tapes on the baseplate until maintenance is performed.

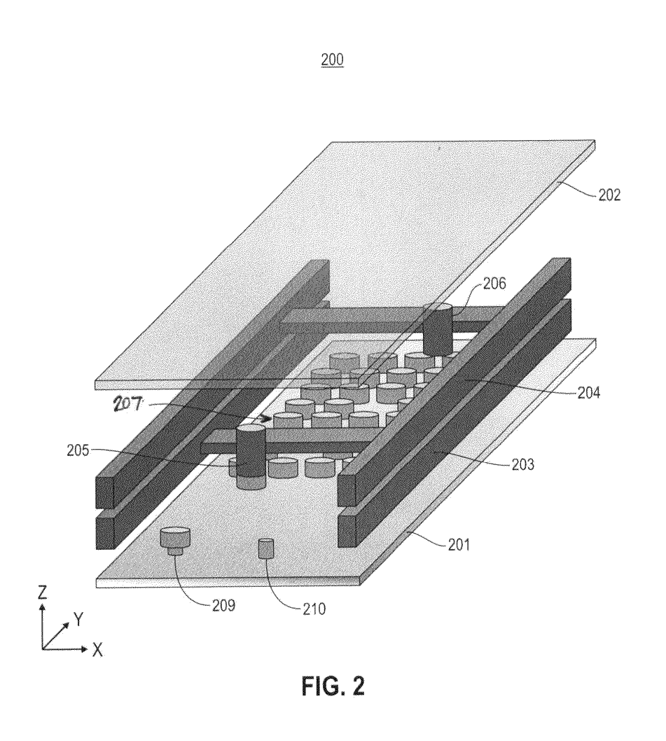

FIG. 2 depicts a system 200, in accordance with one embodiment. As an option, the present system 200 may be implemented in conjunction with features from any other embodiment listed herein, such as those described with reference to the other FIGS. Of course, however, such system 200 and others presented herein may be used in various applications and/or in permutations which may or may not be specifically described in the illustrative embodiments listed herein. Further, the system 200 presented herein may be used in any desired environment.

Referring to FIG. 2, the system 200 includes a tape support surface 201 configured to receive a plurality of tape spools. Each tape may be wound onto a single spool, or on two spools. Moreover, the spool or spools may be incorporated into a cartridge. Accordingly, various embodiments described herein apply equally to single and/or multiple spools, as well as cartridges implementing a spool.

A plurality of robotic accessors 203, 204, are present, and are capable of picking the tape spools from the tape support surface, transporting the tape spools, and releasing (e.g., dropping or placing) the tape spools at one or more drop locations 209, 210. Here, the drop locations are shown on a single side of the spool set 207, but could be positioned anywhere in the system that is accessible by one or more of the pickers 205, 206 of the robotic accessors 203, 204.

As shown, the accessors are coupled to a gantry-type support structure, which in the embodiment shown, includes multiple gantry-type robotic accessors 203, 204. Each robotic accessor may have a configuration similar to that of the robotic accessor described with reference to FIG. 1. The approach of FIG. 2, as well as other embodiments described herein, may be extended to larger stacks of robotic accessors, such as three, four, or more.

Preferably, the robotic accessors 203, 204 are capable of passing each other during the transporting. In one approach, the picker of one or more of the robotic accessors is rotatable about an axis oriented parallel to a plane of the tape support surface 201. In this way, the picker of one accessor can rotate out of the way of the other accessor. Rotation may be effected using any know mechanism, such as via an electrical motor, a hydraulic motor, an actuator, etc. In some approaches, at least one of the accessors is capable of picking tape spools from all portions of at least one of the tape support surfaces configured to receive tape spools.

In one approach, a second robotic accessor 204 is added above a first robotic accessor 203, as shown. If the vertical clearance between the robotic accessors is sufficient, then both robotic accessors can access all the tape spools in the system. This requires the picker of robotic accessor 204 to have sufficient Z range to access tape spools from the additional Z offset. This can be done for example via a mechanism for extending towards the tape support surface for picking the tape spools, such as a lever arm, solenoid, lead screw, a telescoping section, etc.

The pickers 205, 206 may be designed to present a low Z profile to minimize the required spacing. There is a small window where picker 206 is blocked by picker 205, and the system may be programmed to schedule accesses to avoid the blockage, the time of which, in most cases, will be insignificant.

In some embodiments, one or more of the pickers 205, 206 may accommodate multiple tape spools to improve the utilization of the accessor. In this way, accessor operations may be scheduled to improve throughput, such as by reordering drop off and pick up operations.

The approach of FIG. 2 can provide access scaling significantly higher than conventionally achieved, since it has a limited access lockout zone around the robots. Moreover, the loss of access when a robotic accessor fails is limited.

An enclosure 202 may also be present.

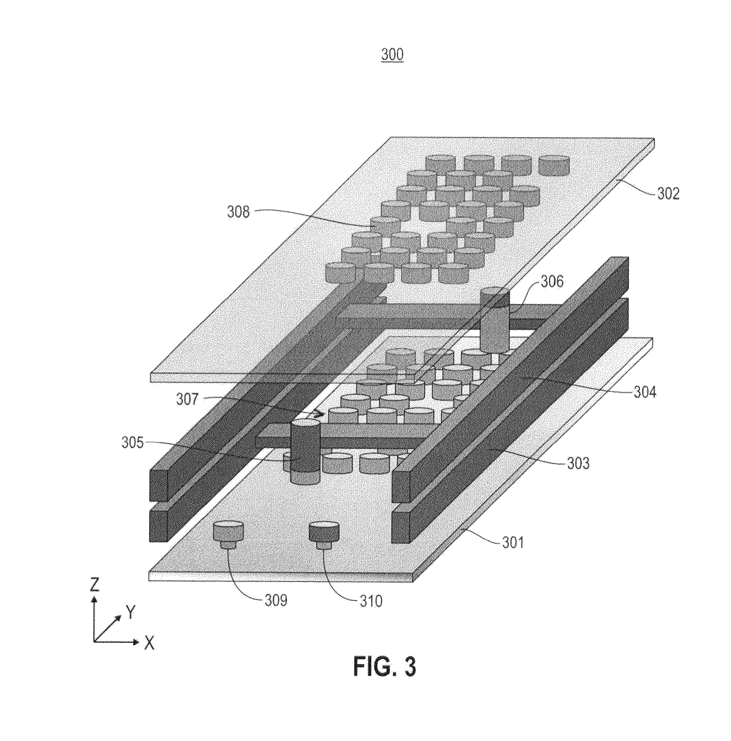

A further improvement is shown in FIG. 3, where the volumetric storage density can be increased. As an option, the system 300 of FIG. 3 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

With continued reference to FIG. 3, the system includes a first tape support surface 301 configured to receive a first set 307 of tape spools, and a second tape support surface 302 facing the first tape support surface 301. A second set 308 of tape spools is disposed on the second tape support surface 302.

A plurality of robotic accessors 303, 304 are capable of picking the tape spools from the tape support surface, transporting the tape spools, and releasing (dropping) the tape spools at one or more drop locations 309, 310. Preferably, the accessors are capable of passing each other during the transporting.

In this system, one or both pickers 305, 306 can access tape spools on either surface 301, 302, such as by rotating the picker along the Y axis, which is parallel to a plane of the tape support surface. If rotation is used, the surface of a tape spool placed on tape support surface 301 is the same coinciding surface of a tape spool placed on tape support surface 302. When the picker picks a tape from the second tape support surface 302 and rotates, the tape will be inverted when placed on the spool drops, and will unwind in the same direction as tapes on the first support surface 301.

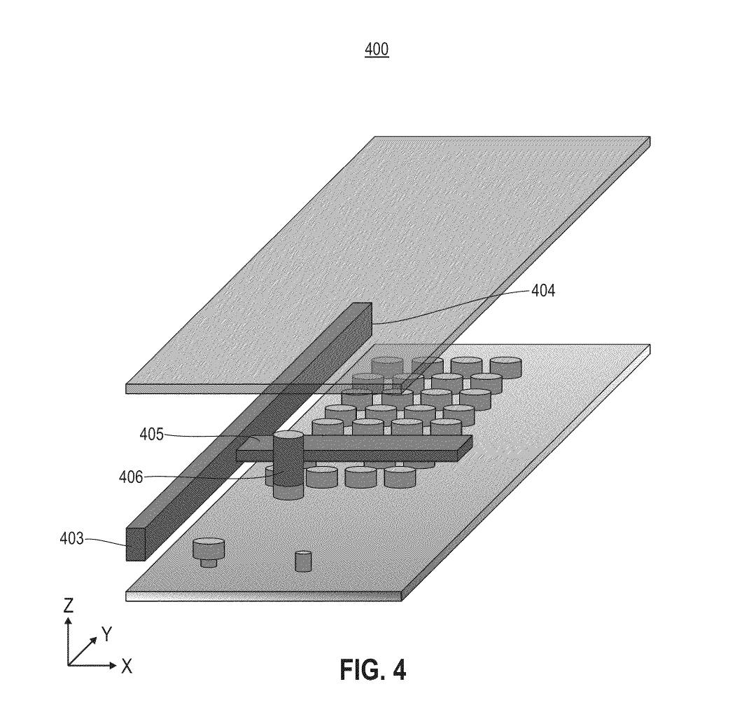

FIG. 4 depicts a system 400, in accordance with one embodiment. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

As shown in FIG. 4, accessor 403 may also be constructed using a cantilever design. Thus, only one side rail 404 and one cross bar 405 are present, and may operate together in a similar manner as that described in FIG. 1. Picker 406 travels along the cross bar 405 such as in a manner described in FIG. 1.

Other accessor designs are possible as well, such as scissor arms, etc. Moreover, the system 400 may include one or more tape support surfaces, such as shown in FIGS. 1-3, and may include similar components.

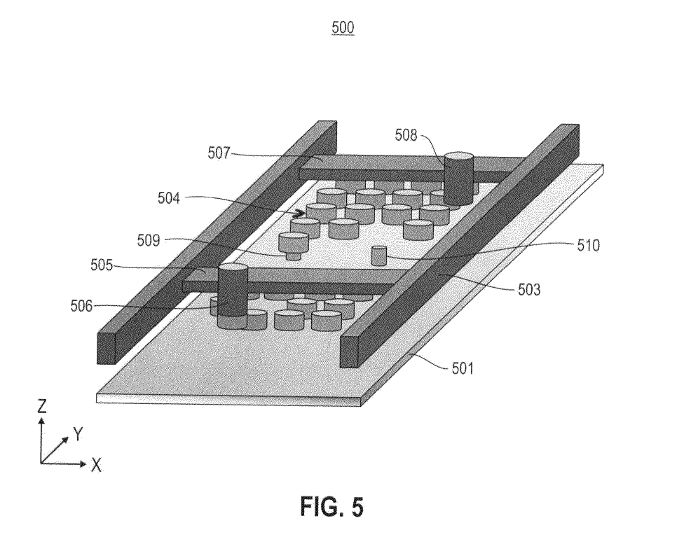

FIG. 5 depicts a system 500, in accordance with one embodiment. As an option, the present system 500 may be implemented in conjunction with features from any other embodiment listed herein, such as those described with reference to the other FIGS. Of course, however, such system 500 and others presented herein may be used in various applications and/or in permutations which may or may not be specifically described in the illustrative embodiments listed herein. Further, the system 500 presented herein may be used in any desired environment.

As shown, the robotic accessor 503 includes a linear accessing mechanism such as a linear motor, rack and pinion, capstan motor coupled to drive belts, or any accessing mechanism known to one of ordinary skill in the art of mechanical motion. Coupled to the linear accessing mechanism is one or more pickers 506, 508. This embodiment preferably enables either picker 506, 508 to access the entire spool set 504, by allowing both cross bars 505, 507 to travel along the length of the tape support surface 501 in the Y direction. In the event of a picker failure, the present embodiment enables redundancy of picker operation for accessing any one spool in spool set 504. During operation of both pickers 506, 508, the present embodiment enables rapid delivery and retrieval from the spool drops 509, 510.

In accordance with another embodiment of the present invention and in reference to FIG. 5, picker 506 and/or picker 508 are replaced with a SCARA robot in which rotating joints enable a picker, similar to pickers 506 and/or 508 to access the entire spool set 504. Thus, this embodiment enables redundancy of picker operation for accessing any one spool in the spool set 504 in a failure event of either picker, and enables rapid delivery and retrieval from either spool drop during operation of both pickers.

As depicted, FIGS. 1-5 generally depict one or more tape support surface in a horizontal orientation, where the tape spools may rest on the lower tape support surface. However, such tape support surfaces may be oriented vertically in various approaches.

Moreover, two or more of the systems may be stacked together to create a high density storage system. For example, the tape support surface and accessors of FIGS. 1, 2, 3, 4 and/or 5 may form a first unit, and a second unit having a configuration like the first unit may be positioned adjacent thereto. A Z-axis transport, such as an elevator, is provided in some embodiments to transport tapes between successive layers or units of the system. A spool drop at the elevator allows accessors on all layers to access tape in the elevator. In another approach, another robotic accessor traveling in the Z-direction may be used to transport tape spools between units.

A controller of any type may control one or more functions of the various systems. Such controller may be programmed with algorithms consistent with the teachings and suggestions presented herein, in a manner that would be apparent to one skilled in the art upon reading the present disclosure.

As noted above, a tape drive and/or winder may be positioned at or near a drop location of any of the systems. A winder may operate in a similar manner as a tape drive, but without an ability to read or write.

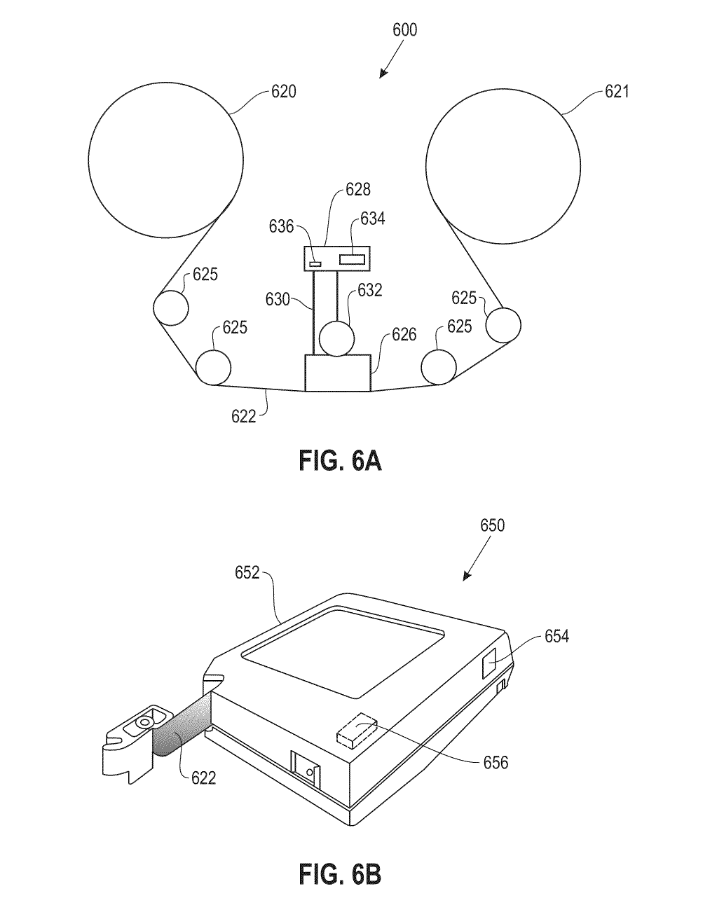

FIG. 6A illustrates a simplified tape drive 600, which may be employed in the context of the present invention. While one specific implementation of a tape drive is shown in FIG. 6A, it should be noted that the embodiments described herein may be implemented in the context of any type of tape drive system.

As shown, a take-up reel 621 and a tape supply reel 620 support a tape 622. Note that either reel shown in FIG. 6A may be a spool transported by an accessor. The tape drive, such as that illustrated in FIG. 6A, may further include drive motor(s) to drive the tape supply cartridge 620 and the take-up reel 621 to move the tape 622 over a tape head 626 of any type. Such head may include an array of readers, writers, or both.

Guides 625 guide the tape 622 across the tape head 626. Such tape head 626 is in turn coupled to a controller 628 via a cable 630. The controller 628, may be or include a processor and/or any logic for controlling any subsystem of the drive 600. For example, the controller 628 typically controls head functions such as servo following, data writing, data reading, etc. The controller 628 may operate under logic known in the art, as well as any logic disclosed herein. The controller 628 may be coupled to a memory 636 of any known type, which may store instructions executable by the controller 628. Moreover, the controller 628 may be configured and/or programmable to perform or control some or all of the methodology presented herein. Thus, the controller may be considered configured to perform various operations by way of logic programmed into a chip; software, firmware, or other instructions being available to a processor; etc. and combinations thereof.

The cable 630 may include read/write circuits to transmit data to the head 626 to be recorded on the tape 622 and to receive data read by the head 626 from the tape 622. An actuator 632 controls position of the head 626 relative to the tape 622.

An interface 634 may also be provided for communication between the tape drive 600 and a host (integral or external) to send and receive the data and for controlling the operation of the tape drive 600 and communicating the status of the tape drive 600 to the host, all as will be understood by those of skill in the art.

As noted above, the various systems may operate with single tape spools, multiple tape spools, and/or tape cartridges. FIG. 6B illustrates an exemplary tape cartridge 650 according to one embodiment. As shown, the tape cartridge 650 includes a housing 652, a tape 622 in the housing 652, and a nonvolatile memory 656 coupled to the housing 652. In some approaches, the nonvolatile memory 656 may be embedded inside the housing 652, as shown in FIG. 6B. In more approaches, the nonvolatile memory 656 may be attached to the inside or outside of the housing 652 without modification of the housing 652. For example, the nonvolatile memory may be embedded in a self-adhesive label 654. In one preferred embodiment, the nonvolatile memory 656 may be a Flash memory device, ROM device, etc., embedded into or coupled to the inside or outside of the tape cartridge 650. The nonvolatile memory is accessible by the tape drive and the tape operating software (the driver software), and/or other device.

Any type of tape threading system known in the art may be adapted for use with the systems described herein, according to various embodiments. For example, if tape reels are used individually (not as pairs), a standard threader mechanism may be used to thread the tape reel onto the tape drive, according to one embodiment. Storing the tape on pairs of reels has an advantage in that after loading, the tape is ready to be used and does not need to be wound onto another inboard reel. Also, when the tape is finished being used, both reels may be removed with the tape, and the tape does not need to be unwound from the inboard reel in order to be removed.

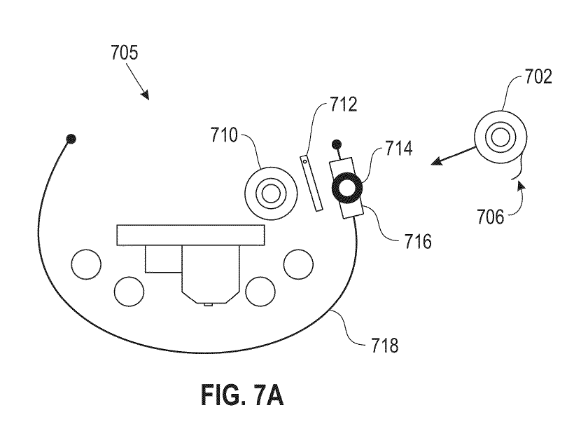

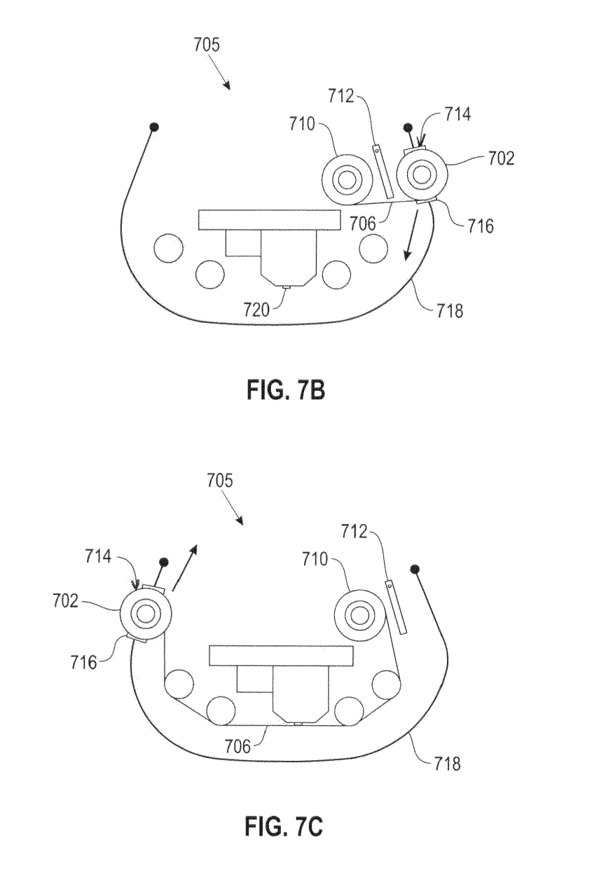

In one approach, where the tape is stored on one reel only, the accessor or other mechanism may move an end of the tape not on the reel to secure it to an inboard drive wheel, as described in relation to FIGS. 7A-7C. The precision of the accessor motion may be much greater than that of a leader pin loader mechanism currently used in tape drives, in some approaches.

In another embodiment, as shown in FIGS. 7A-7C, a single reel 702 of tape 706 may be loaded onto a reel chuck and motor 714 which are fixed to a carriage 716 that is adapted to follow a guide 718 that allows for motion of the chuck 714 around the tape drive 705 to facilitate threading of the tape 706. Before loading the reel 702 on the chuck 714, the chuck 714 is brought into proximity of the inboard (take-up) reel 710, as shown in FIG. 7A. After the robotic accessor (not shown for clarity) places the reel 702 on the chuck 714, a mechanism 712 attaches the end of the tape 706 to the take-up reel 710. See FIG. 7B. At this point, the tape 706 may be transferred between reels 702 and 710 as part of a preliminary locate operation, before the tape 706 contacts the recording head 720 or any guide surfaces, such as rollers, thus enabling faster tape locate with reduced tape damage and drive wear. Then, the chuck and reel motor 714 and tape reel 702 are moved along the guide 718 to a final position, as shown in FIG. 7C, where the tape 706 may be read from or written to.

In another embodiment, rather than moving the library reel 702 and carriage 716, the take-up reel 710 and its motor may be moved to thread the tape drive 204. In yet another embodiment, if the tape 706 is stored on a pair of reels, the robotic accessor may position the two reels directly on the tape drive 705, where the tape 706 may be located before threading.

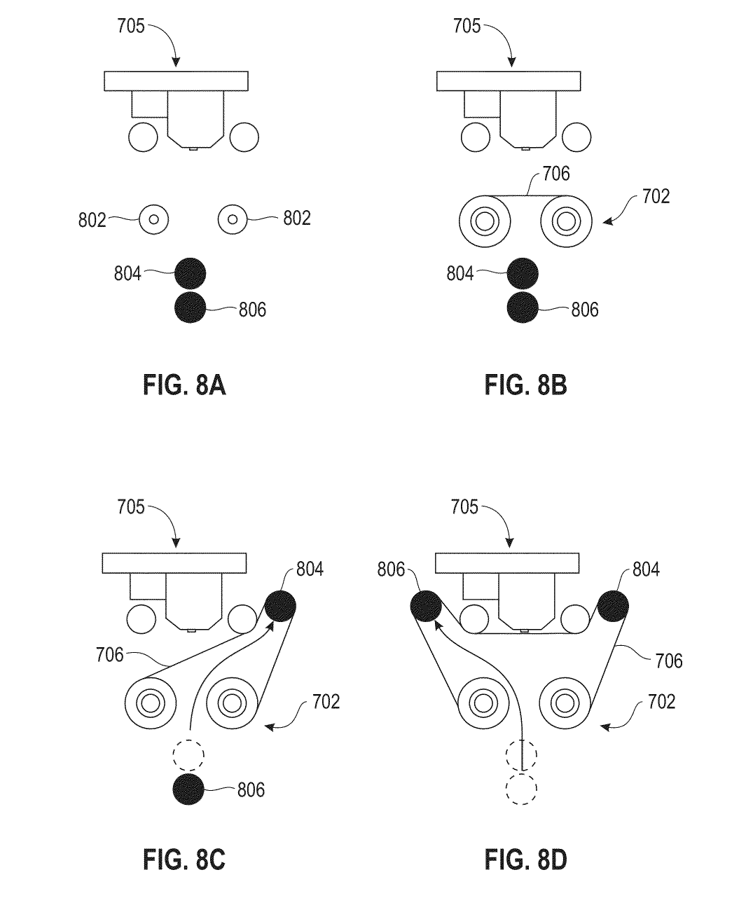

Alternatively, as shown in FIGS. 8A-8D, the tape 706 may be held on two tape reels 702, and a method may be used which avoids the unreliability of a leader pin. In this approach, the reel drive chucks 802 may be spaced with the same close spacing of the tape reels 702 in their storage position. The robotic accessor places the tape reels 202 on the chucks 802, as shown in FIG. 8B, and two moveable rollers 804, 806 sequentially thread the tape 706 in position. First, roller 804 threads the tape 706, as shown in FIG. 8C, and then roller 806 threads the tape 706, as shown in FIG. 8D. The tape 706 may locate before the rollers 804, 806 move into their final position, thus avoiding the extra wear and control difficulties associated with contact of the tape 706 with the roller 806 or other guide surfaces and the head. Alternately, two smooth cylinders which form air bearings may be used to thread the tape drive, in another embodiment.

In one embodiment, each reel may be large enough (e.g., the flanges are big enough) to hold the entire length of tape that can be wound onto the reel(s), if all the tape is to be accessed. If the tape is stored in pairs of these large reels, the capacity of the library may be reduced by a factor of two from what it may be by using single reels.

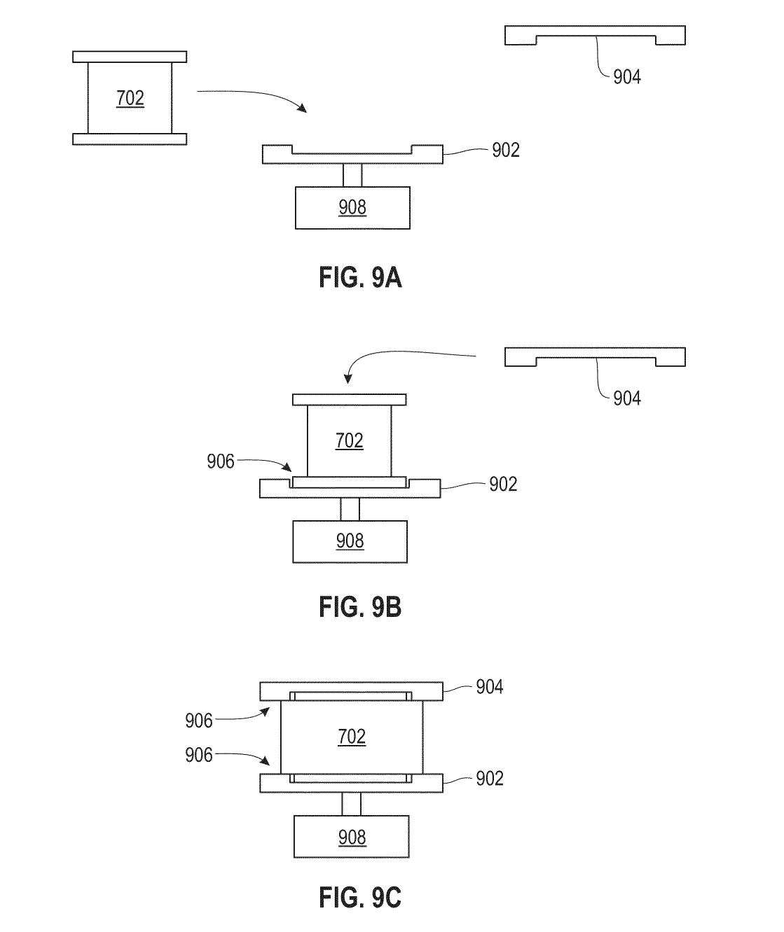

In another approach, the tape may be stored on a pair of reels, where at least one reel is not large enough to accept the entire length of tape. As shown in FIGS. 9A-9C, a reel-size reduction may be effected by incorporating temporary flange extenders 902, 904 in the tape drive. In the tape drive, a temporary flange extender 902 is fixed to the motor/reel chuck 908 so that the reel flange 906 is extended when it is on the drive. Once the reels 702 are in the drive, another flange extender 904 is placed on the top of each of the reels 702, so that tape can be spooled onto one of the reels. Before the tape reels 702 are unloaded from the tape drive, the tape is spooled back evenly between the tape reels 702, so that it lies only between the permanent flanges 906 on the tape reels 702.

In another approach, a packing roller may be used to keep the tape on the reel after its diameter becomes bigger than the flange.

To assist in navigation of the robotic accessor, at least one of the tape support surfaces may include an optical pattern usable for navigation of the robotic accessor, and the robotic accessor may be configured for recognizing the optical pattern.

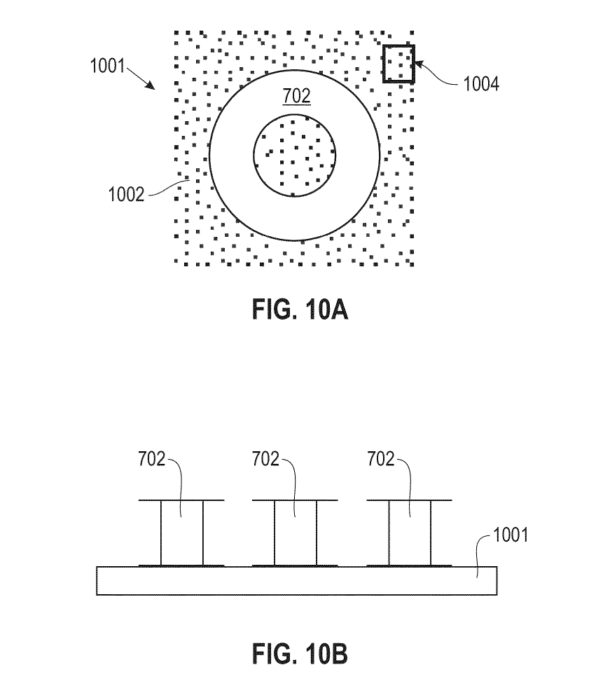

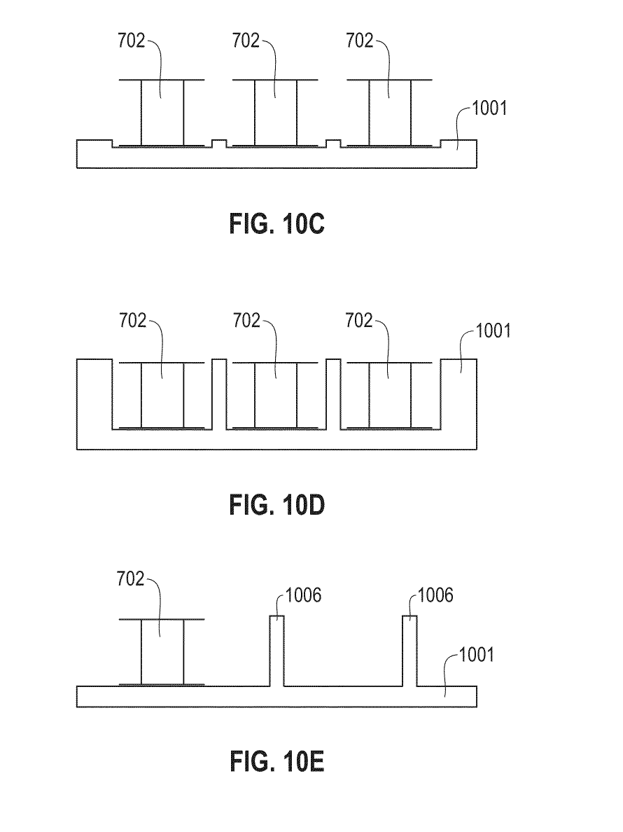

As shown in FIG. 10A, the lower surface or floor 1001, for example, may include an optical pattern 1002 designed for the robotic accessor to locate its position. This optical pattern 1002 may be a rectangular grid extending over the entire floor 1001, with each grid square 1004 labeled with readable code identifying the row and column of the particular grid square 1004. This readable code may take any form as would be understood by one of skill in the art.

The floor 1001 may be planar, as shown in FIG. 10B, covered with small indentations as shown in FIG. 10C, have a lattice defining receptacle areas in which the tape reels 702 are positioned as shown in FIG. 10D, etc., according to various embodiments. In another approach, as shown in FIG. 10E, posts 1006 may extend upwardly from the lower surface 1001 to hold reels in place. The posts 1006 may be used in combination with other approaches, such as those shown in FIGS. 10B and 10C.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

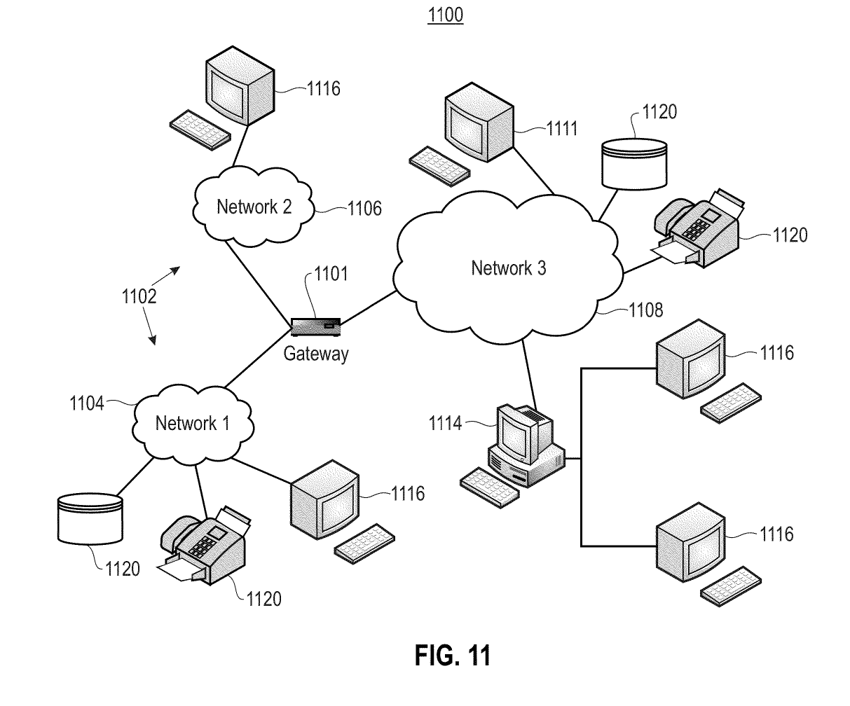

FIG. 11 illustrates a network architecture 1100, in accordance with one embodiment. As an option, the network architecture 1100 may be implemented in conjunction with features from any other embodiment listed herein, such as those described with reference to the other FIGS. Of course, however, such network architecture 1100 and others presented herein may be used in various applications and/or in permutations which may or may not be specifically described in the illustrative embodiments listed herein. Further, the network architecture 1100 presented herein may be used in any desired environment.

As shown in FIG. 11, a plurality of remote networks 1102 are provided including a first remote network 1104 and a second remote network 1106. A gateway 1101 may be coupled between the remote networks 1102 and a proximate network 1108. In the context of the present network architecture 1100, the networks 1104, 1106 may each take any form including, but not limited to a LAN, a WAN such as the Internet, public switched telephone network (PSTN), internal telephone network, etc.

In use, the gateway 1101 serves as an entrance point from the remote networks 1102 to the proximate network 1108. As such, the gateway 1101 may function as a router, which is capable of directing a given packet of data that arrives at the gateway 1101, and a switch, which furnishes the actual path in and out of the gateway 1101 for a given packet.

Further included is at least one data server 1114 coupled to the proximate network 1108, and which is accessible from the remote networks 1102 via the gateway 1101. It should be noted that the data server(s) 1114 may include any type of computing device/groupware. Coupled to each data server 1114 is a plurality of user devices 1116. Such user devices 1116 may include a desktop computer, lap-top computer, hand-held computer, printer or any other type of logic. It should be noted that a user device 1111 may also be directly coupled to any of the networks, in one embodiment.

A peripheral 1120 or series of peripherals 1120, e.g., facsimile machines, printers, networked and/or local storage units or systems, etc., may be coupled to one or more of the networks 1104, 1106, 1108. It should be noted that databases and/or additional components may be utilized with, or integrated into, any type of network element coupled to the networks 1104, 1106, 1108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of a hypervisor, in some embodiments.

In more approaches, one or more networks 1104, 1106, 1108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

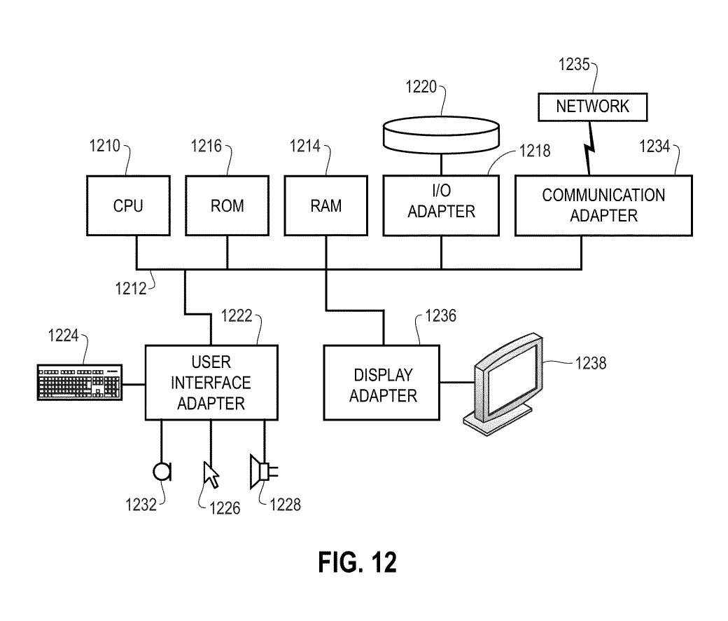

FIG. 12 shows a representative hardware environment associated with a user device 1116 and/or server 1114 of FIG. 11, in accordance with one embodiment. Such figure illustrates a typical hardware configuration of a workstation having a central processing unit 1210, such as a microprocessor, and a number of other units interconnected via a system bus 1212.

The workstation shown in FIG. 12 includes a Random Access Memory (RAM) 1214, Read Only Memory (ROM) 1216, an I/O adapter 1218 for connecting peripheral devices such as disk storage units 1220 to the bus 1212, a user interface adapter 1222 for connecting a keyboard 1224, a mouse 1226, a speaker 1228, a microphone 1232, and/or other user interface devices such as a touch screen and a digital camera (not shown) to the bus 1212, communication adapter 1234 for connecting the workstation to a communication network 1235 (e.g., a data processing network) and a display adapter 1236 for connecting the bus 1212 to a display device 1238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A system, comprising:
a tape support surface configured to receive a plurality of tape spools; and
a plurality of robotic accessors capable of picking the tape spools from the tape support surface, transporting the tape spools, and releasing the tape spools at a drop location;
wherein the accessors are capable of passing each other during the transporting.

2. The system of claim 1, wherein the tape support surface is horizontal, wherein the tape spools rest on the tape support surface.

3. The system of claim 1, wherein the accessors each have a picker that is rotatable about an axis oriented parallel to a plane of the tape support surface.

4. The system of claim 1, wherein the accessors are coupled to a gantry-type support structure.

5. The system of claim 1, wherein the accessors are coupled to a cantilever-type support structure.

6. The system of claim 1, wherein a second of the accessors positioned farther from the tape support surface than a first of the accessors includes a mechanism for extending towards the tape support surface for picking the tape spools.

7. The system of claim 1, further comprising a second tape support surface facing the tape support surface, wherein at least one of the accessors is capable of picking tape spools from both tape support surfaces.

8. The system of claim 7, wherein at least two of the accessors are capable of picking tape spools from both tape support surfaces.

9. The system of claim 7, wherein the at least one of the accessors that is capable of picking tape spools from both tape support surfaces has a picker that is rotatable about an axis oriented parallel to a plane of the tape support surface.

10. The system of claim 7, wherein tapes on the tape spools are oriented such that an unwind direction thereof is in a first direction for the tape spools on the tape support surface and in a second direction opposite the first direction for the tape spools on the second tape support surface.

11. The system of claim 1, wherein at least one of the accessors is capable of picking the tape spools from all portions of the tape support surface that are configured to receive the tape spools.

12. The system of claim 1, further comprising a tape drive positioned at or near the drop location.

13. The system of claim 1, further comprising a winder positioned at or near the drop location.

14. The system of claim 1, wherein the tape support surface and accessors form a first unit, and further comprising a second unit having a configuration like the first unit and positioned adjacent thereto.

15. The system of claim 14, further comprising an elevator for transporting tape spools between the first and second units.

16. A system, comprising:
a first tape support surface configured to receive a plurality of tape spools;
a second tape support surface facing the first tape support surface; and
a plurality of robotic accessors capable of picking the tape spools from the tape support surface, transporting the tape spools, and releasing the tape spools at a drop location,
wherein at least one of the accessors is capable of picking tape spools from both tape support surfaces.

17. The system of claim 16, wherein the accessors are capable of passing each other during the transporting.

18. The system of claim 16, wherein both accessors are capable of picking tape spools from both tape support surfaces.

19. The system of claim 16, wherein the at least one of the accessors that is capable of picking tape spools from both tape support surfaces has a picker that is rotatable about an axis oriented parallel to a plane of the tape support surface.

20. The system of claim 16, wherein an accessor is capable of picking tape spools from an entire tape support surface.
